(19) United States
(12) Patent Application Publication
(10) Pub. No.: US 2014/0165763 A1
(43) Pub. Date: Jun. 19, 2014

(54) SHIFT CONTROL DEVICE FOR A BICYCLE DERAILLEUR

(71) Applicant: Jonathan K. Harris, Tulsa, OK (US)

(72) Inventor: Jonathan K. Harris, Tulsa, OK (US)

(21) Appl. No.: 14/073,134

(22) Filed: Nov. 6, 2013

Related U.S. Application Data
(60) Provisional application No. 61/739,467, filed on Dec. 19, 2012.

(51) Int. Cl. F16H 59/04

(52) U.S. Cl. CPC F16H 59/044
USPC 74/473.12

(57) ABSTRACT

The invention relates to a shift control device for an electronic derailleur of a racing bicycle. The control device includes a support body conventionally mounted to handlebars of the bicycle. The control device includes a plurality of electrical switches for selectively controlling a gear change of the bicycle. An upper set of switches operate an electronic motor of a derailleur for controlling a gear change towards a higher or a lower gear ratio, and are located toward an upper portion of the support body. A lower set of switches are located toward a lower portion of the support body, and also operate the electrical motor of the derailleur for controlling the gear change. The upper set of switches and the lower set of switches are each respectively positioned on the control device to minimize interference and/or mis-shifting during various riding positions by the cyclist.

### CROSS REFERENCE TO RELATED APPLICATIONS

This application claims the benefit of U.S. Provisional Patent Application Ser. No. 61/739,467 entitled “Shift Control Device for a Bicycle Derailleur,” filed Dec. 19, 2012, which is incorporated herein by reference in its entirety.

### BACKGROUND OF THE INVENTION

1. Field of the Invention

This invention relates generally to a shift control device for an electronic bicycle derailleur, and more particular to an improved electronic shift control device having dual shifting positions using an upper set and a lower set of shift switches.

2. Description of the Related Art

Electronic gear-shifting systems change gears on a racing bicycle allowing cyclists to shift with electronic switches instead of using conventional control levers. The switches are connected by wire or wirelessly to a portable power source, such as a battery pack, and to a small electric motor that drives a derailleur, switching the chain from cog to cog. Electronic systems can switch gears faster, weigh less and require less maintenance than conventional mechanical systems. In addition, electronic systems allow for an accurate and effortless shift and eliminate the need for the cyclist to switch hand positions in order to shift gears while riding.

It is therefore desirable to provide a shift control device for an electronic bicycle derailleur that affords a cyclist dual shifting positions while riding using two (2) sets of shift switches.

It is further desirable to provide a shift control device that affords improved safety by minimizing the need for a cyclist to move his/her hands to shift gears during riding.

It is yet further desirable to provide a shift control device that provides for multiple gripping positions by a cyclist, and in particular two additional options for hand placement for optimal shifting versus existing shift lever designs.

It is still further desirable to provide a shift control device that affords a cyclist a competitive edge with the ability to shift gears under a wider variety of racing conditions, i.e., “on top,” out of saddle climbing, sprinting or other vigorous “in the drops” riding, and without the risk of an inadvertent operation of the strategically positioned electronic switches of the control device.

It is still yet further desirable to provide a shift control device that is compatible with existing electronic derailleurs allowing for internal components to be easily installed.

### BRIEF SUMMARY OF THE INVENTION

In general, the invention relates to a shift control device for a derailleur of a bicycle. The control device includes a support body securable to handlebars of the bicycle and a brake lever pivotally secured to the support body. The brake lever has a top end pivotally secured to the support body about an axis set in a transverse direction with respect to a longitudinal vertical plane of the bicycle The support body also includes an upper set of electronic switches and a lower set of electronic switches in communication with a motor controlling the derailleur of the bicycle. The upper set of switches may be located toward an upper, frontal portion of the support body. The upper set of switches can also be located on an inner face and separated by a thumb recess of the support body. The lower set of switches located toward a lower portion of the support body. The lower set of switches can be positioned on an inward bias toward a center line of the bicycle. The lower set of switches could be proximately positioned in relation to each other.

The upper set of electronic switches and the lower set of electronic switches respectively operate the motor of the derailleur for controlling a gear change towards a higher or a lower gear ratio of the bicycle. The upper set of switches are positioned on the upper portion of the support body enabling a cyclist to selectively operate the upper set of switches with his/her thumb or finger. The upper set of switches can include a first upper switch to shift the derailleur towards a higher gear ratio and a second upper switch to shift the derailleur towards a lower gear ratio. The lower set of switches can further include a first lower switch to shift the derailleur towards a higher gear ratio and a second lower switch to shift the derailleur towards a lower gear ratio. The lower set of switches may protrude from the support body toward the brake lever. Moreover, the upper set of switches and/or the lower set of switches can be a push button-type switch positioned such that each can respectively be operated by the cyclist's thumb and/or fingers while the cyclist's hand engages the support body or the curved part of the handlebars.

Other advantages and features of the invention will be apparent from the following description and from the claims.

### BRIEF DESCRIPTION OF THE DRAWINGS

FIG. 1 is a first side view of an example of a control device in accordance with an illustrative embodiment of the shift control device for an electronic bicycle derailleur disclosed herein;

FIG. 2 is a second side view of the control device shown in FIG. 1;

FIGS. 3A and 3B are perspective views of the control device illustrated in FIG. 1;

FIGS. 4A and 4B are additional perspective views of the control device illustrated in FIG. 1; and

FIG. 5 is a perspective view of a bicycle having a set of shift control devices in accordance with an illustrative embodiment of the invention disclosed herein.

### DETAILED DESCRIPTION OF THE INVENTION

The devices and methods discussed herein are merely illustrative of specific manners in which to make and use this invention and are not to be interpreted as limiting in scope.

While the invention has been described with a certain degree of particularity, it is to be noted that many modifications may be made in the construction and the arrangement of the structural and function details disclosed herein without departing from the scope of the invention. It is understood that the invention is not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “inward,” “outward,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the device be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece.

Referring to the figures of the drawings, wherein like numerals of reference designate like elements throughout the several views, a shift control device 10 for an electronic derailleur (not shown) of a racing bicycle (not shown). The control device 10 includes a support body 12 conventionally mounted to handlebars 14 of the bicycle, such as using a metal clamp 16 connected to a fastener 18 embedded within the support body 12. The control device 10 includes a brake lever 20 secured to the support body 12 such that the brake lever 20 may be articulated in a convention manner by a cyclist, such as having a top end of the brake lever 20 pivotally secured to the support body 12 about an axis 22 set in a transverse direction with respect to the longitudinal vertical plane of the bicycle. The brake lever 20 is connected to a brake cable 24 for controlling a brake (not shown) of the bicycle.

The support body 12 includes a plurality of electrical switches for selectively controlling a gear change of the bicycle. An upper set of switches 26 operate a motor (not shown) of the derailleur for controlling a gear change towards a higher or a lower gear ratio. For example, the upper set of switches 26 can include a first upper switch 26a to actuate the motor causing the chain to shift towards a higher gear ratio and a second upper switch 26b to shift the chain towards a lower gear ratio.

The upper set of switches 26 may be located toward an upper, frontal portion of the support body 12, and may be shielded within a recessed groove 28 to minimize interference and/or mis-shifting, such as from errant hand movements, during “on the hoods” riding by the cyclist where his/her hands are positioned on top of the support body 12 of the control device 10. In this non-limiting embodiment, the first upper switch 26a would be positioned inwardly within the recessed groove 28 toward a center line of the bicycle, and the second upper switch 26b may be positioned outwardly within the recessed groove 28 away from the center line of the bicycle, enabling the cyclist to selectively operate the upper set of switches 26 with his/her thumb or finger.

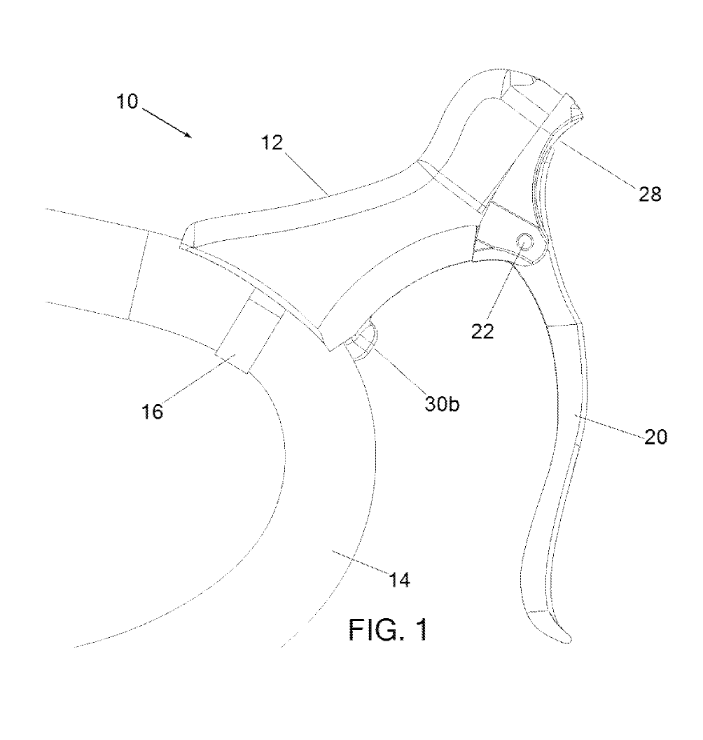

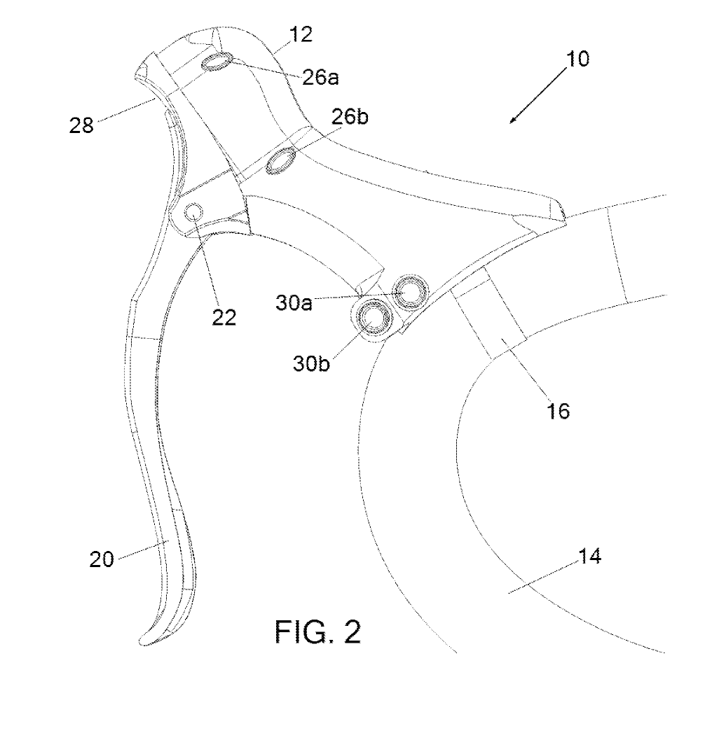

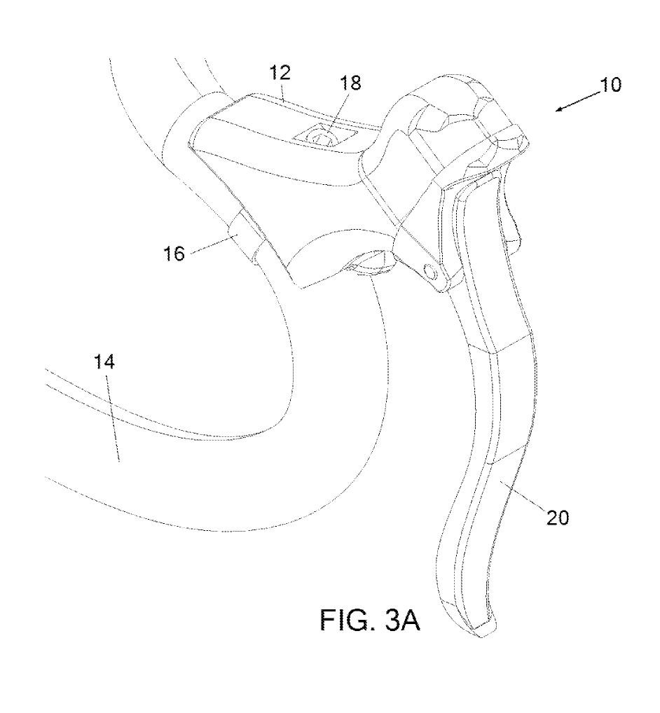

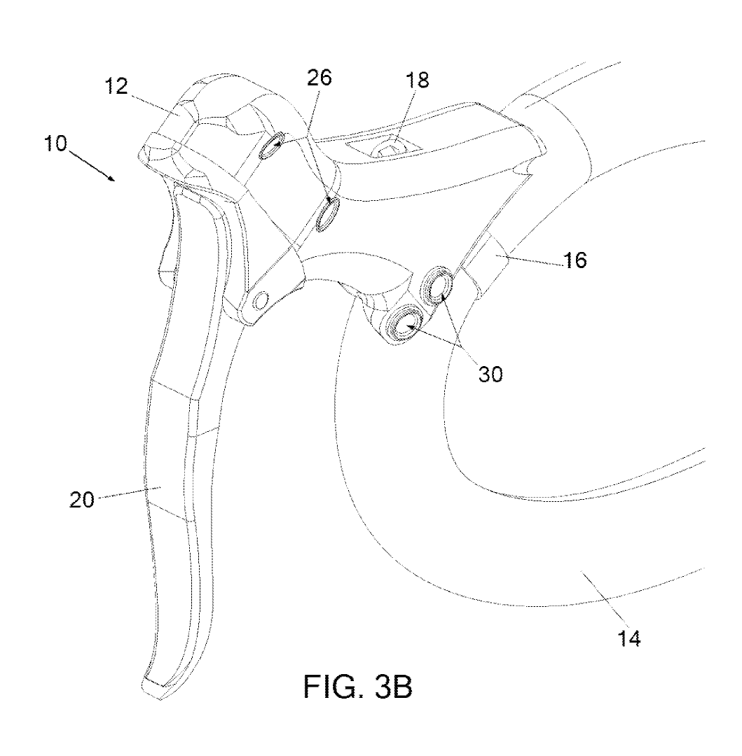

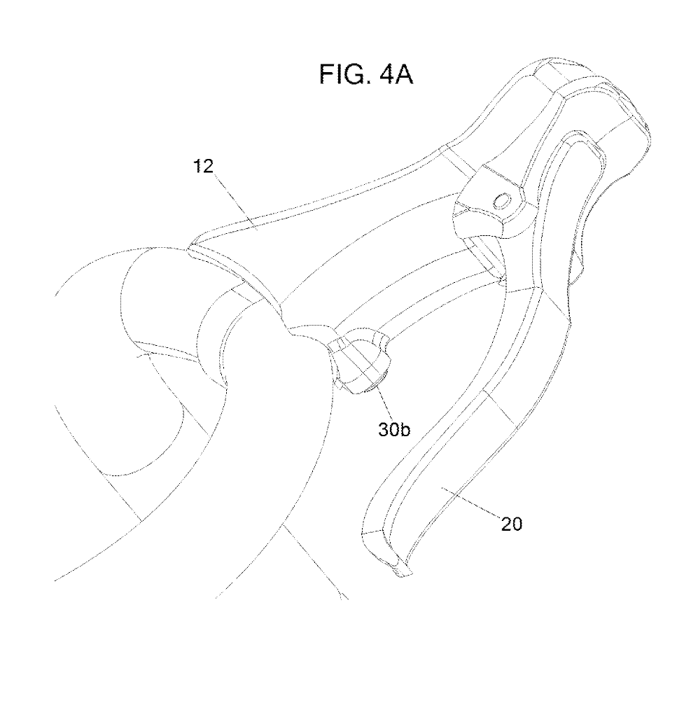

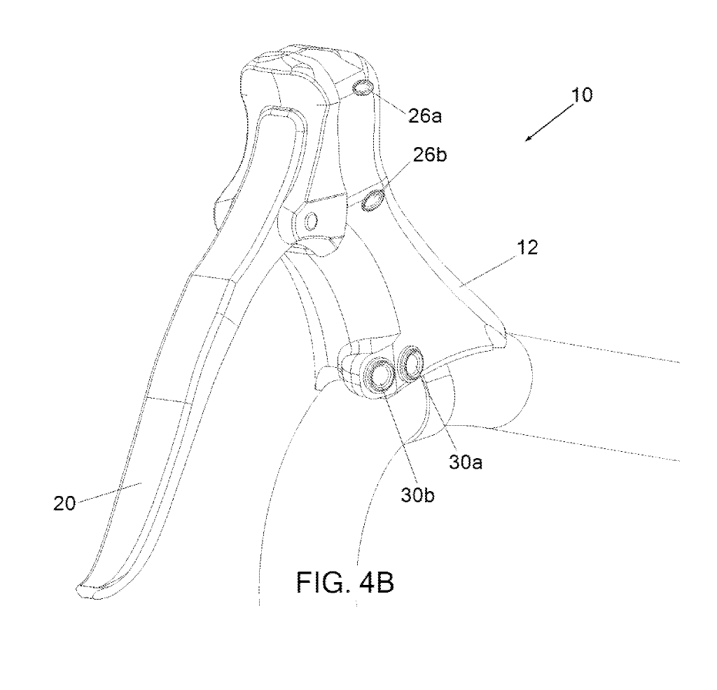

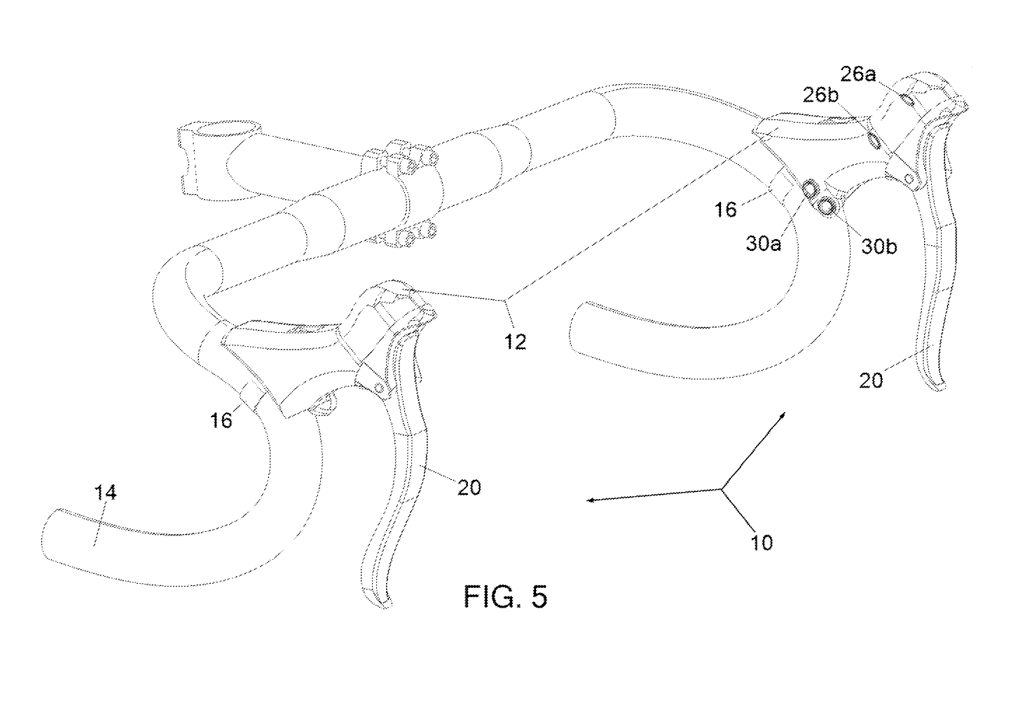

As exemplified in FIGS. 1 through 5, the upper set of switches 26 are located in a spaced relation of an inner face of the support body 12. In this embodiment, the first upper switch 26a is positioned on the inner face toward the upper frontal portion of the support body 12 so as to be accessible to the cyclist's thumb during “on the hoods” riding. The second upper switch 26b is located below a thumb recess 32 on the inner face of the support body 12 and is also positioned to be accessible by the cyclist's thumb during “on the hoods” riding. The position of the upper set of switches 26 illustrated in the figures decrease hand movements required by the cyclist to shift, decrease mis-shifting and increase the cyclist's ability to shift while his/her hands are at different positions.

A lower set of switches 30 are located toward a lower portion of the support body 12, and also operate the motor of the derailleur for controlling the gear change during “in the drops” riding by the cyclist where his/her hands are positioned lower on the handlebars 14 of the bicycle. Similar to the upper set of switches 26, the lower set of switches 30 includes a first lower switch 30a to control gear changes, such as towards higher gear ratios, while actuation of a second lower switch 30b causes an opposing gear change, such as towards lower gear ratios. The lower set of switches 30 may protrude from the support body 12 toward the brake lever 20, and may be positioned on a bias toward the center line of the bicycle to minimize accidental shifting during “in the drops” riding by the cyclist. As illustrated in FIGS. 1 through 5, the lower set of switches 30 are positioned on the inner face of the lower portion of the support body 12. In this example, the first lower switch 30a is positioned proximate to the second lower switch 30b, such as the first lower switch 30a being adjacent to the second lower switch 30b.

The control device 10 is illustrated in the drawings as a right-hand side control device for controlling a rear derailleur, but is not so limited. A left-handed side control device for controlling a front derailleur is the mirror image and symmetrical with respect to the right-handed side control device. Consequently in the case of the left-handed side control device, the particular orientation of the first upper switch 26a and the second upper switch 26b of the upper set of switches 26, along with the first lower switch 30a and the second lower switch 30b of the lower set of switches 30 are mirror-symmetrical such that the first upper switch 26a and the first lower switch 30a are positioned inwardly toward the center line of the bicycle, and the second upper switch 26b and the second lower switch 30b are positioned outwardly away from the center line of the bicycle.

As illustrated, the switches of both the upper set of switches 26 and the lower set of switches 30 are a push button-type switch positioned such that each can respectively be operated by the cyclist's thumb and/or fingers while the cyclist's hand engages the support body 12 or the curved part of the handlebars 14.

Whereas, the devices have been described in relation to the drawings and claims, it should be understood that other and further modifications, apart from those shown or suggested herein, may be made within the scope of this invention.

What is claimed is:

1. A shift control device for a derailleur of a bicycle, said control device comprising:
a support body constructed to be securable to handlebars of said bicycle, said support body comprising:
an upper set of electronic switches in communication with a motor controlling said derailleur of said bicycle, said upper set of switches located toward an upper portion of said support body; and
a lower set of electronic switches in communication with said motor controlling said derailleur of said bicycle, said lower set of switches located on an inner face toward a lower portion of said support body; and
a brake lever pivotally secured to said support body.

2. The control device of claim 1 wherein said upper set of electronic switches and/or said lower set of electronic switches operate said motor of said derailleur for controlling a gear change towards a higher or a lower gear ratio of said bicycle.

3. The control device of claim 1 wherein said upper set of switches further comprises a first upper switch to shift said derailleur towards a higher gear ratio and a second upper switch to shift said derailleur towards a lower gear ratio.

4. The control device of claim 3 further comprising said upper set of switches located on an upper, frontal portion of said support body enabling a cyclist to selectively operate said upper set of switches with his/her thumb or finger.

5. The control device of claim 3 wherein said first upper switch and said second upper switch are positioned on an inner face of said support body.

6. The control device of claim 5 wherein said first upper switch and said second upper switch are separated by a thumb recess on said support body.

7. The control device of claim 1 wherein said upper set of switches are positioned on an inner face of said support body.

8. The control device of claim 7 wherein each switch of said upper set of switches are separated by a thumb recess on said support body.

9. The control device of claim 1 wherein each switch of said upper set of switches are separated by a thumb recess on said support body.

10. The control device of claim 1 wherein said brake lever has a top end pivotally secured to the support body about an axis set in a transverse direction with respect to a longitudinal vertical plane of the bicycle.

11. The control device of claim 1 wherein and said lower set of switches is positioned on an inward bias toward a center line of said bicycle.

12. The control device of claim 11 wherein said lower set of switches protrude from said support body toward the brake lever.

13. The control device of claim 1 wherein said lower set of switches further comprises a first lower switch to shift said derailleur towards a higher gear ratio and a second lower switch to shift said derailleur towards a lower gear ratio.

14. The control device of claim 13 wherein said first lower switch is positioned proximate to said second lower switch on said support body.

15. The control device of claim 1 wherein said upper set of switches and/or said lower set of switches further comprises a push button-type switch.

16. The control device of claim 15 wherein said push-button-type switch is positioned such that each can respectively be operated by the cyclist's thumb and/or fingers while the cyclist's hand engages the support body or the curved part of the handlebars.
